(19) United States
(12) Patent Application Publication
(10) Pub. No.: US 2007/0100661 A1
(43) Pub. Date: May 3, 2007

(54) Method to reduce health care costs

(76) Inventor: Dino Scorziello, Akron, OH (US)

Correspondence Address: DINO SCORZIELLO, 2037 WILMICH DR, AKRON, OH, 44319, US

(21) Appl. No.: 11/262,349

(22) Filed: Oct. 31, 2005

(51) Int. Cl. G06Q 10/00; G06F 9/44

(52) U.S. Cl. 705/2; 705/7

(57) ABSTRACT

A method to reduce healthcare costs consisting of, the costs to treat a patient at a local medical facility and the costs to treat the patient at a distant medical facility. If the patient requires emergency treatment or is unable to travel then he/she is treated at a local medical facility. If the patient is able to travel and the costs to treat him/her are less at the distant medical facility, then he/she will be sent to the distant medical facility for treatment. If the costs of treating the patient are less at the local medical facility then the patient is sent to the local medical facility for treatment.

### CROSS-REFERENCE TO RELATED APPLICATIONS

Not applicable.

### BACKGROUND

1. Field of Invention

This invention relates to healthcare management specifically a method to select a low cost medical facility to treat patients and save money.

2. Description of Prior Art

The rising cost of healthcare is threatening the competitiveness and viability of some companies that offer healthcare benefits to their employees and retirees. Recently companies in the automotive and airline industries have had to reduce the healthcare benefits provided to their employees to avoid bankruptcy and to increase their credit rating. Some companies do not offer any healthcare benefits to their employees in order to remain competitive in an environment of meager profit margins. People who have no healthcare benefits must rely on government supported medical systems. Companies that do not offer healthcare benefits or that go bankrupt to avoid paying healthcare benefits to their retirees are effectively shifting the cost of healthcare onto the taxpayer. However, as unemployment rates increase less tax revenue is collected, shifting more of the healthcare burden onto fewer workers, resulting in increased taxes. Therefore a need exists to be able to identify low cost medical facilities for patients in need of medical treatment. Savings realized from using low cost medical facilities will result in lower healthcare costs for companies providing benefits to their employees and retirees.

### SUMMARY

In accordance with the present invention, the cost of treating a patient is determined both at a local medical facility and at a distant medical facility. The patient is sent to the least expensive medical facility for treatment, provided he/she is able to go.

### OBJECTS AND ADVANTAGES

Accordingly, several objects and advantages of my invention are:
a) to reduce the healthcare costs incurred by a company providing healthcare benefits to its employees and retirees; and
b) to provide a means for companies to remain competitive by reducing their healthcare costs.
   Further objects and advantages are to allow companies that do not currently offer healthcare benefits to their employees, the ability to afford them, and thus begin to provide healthcare benefits to their employees. Still further objects and advantages will become apparent from a consideration of the ensuing description and drawing.

### DRAWING FIGURES

FIG. 1 shows a flow diagram explaining how the decisions are made to reduce a company's healthcare costs.

### REFERENCE NUMERALS IN DRAWINGS

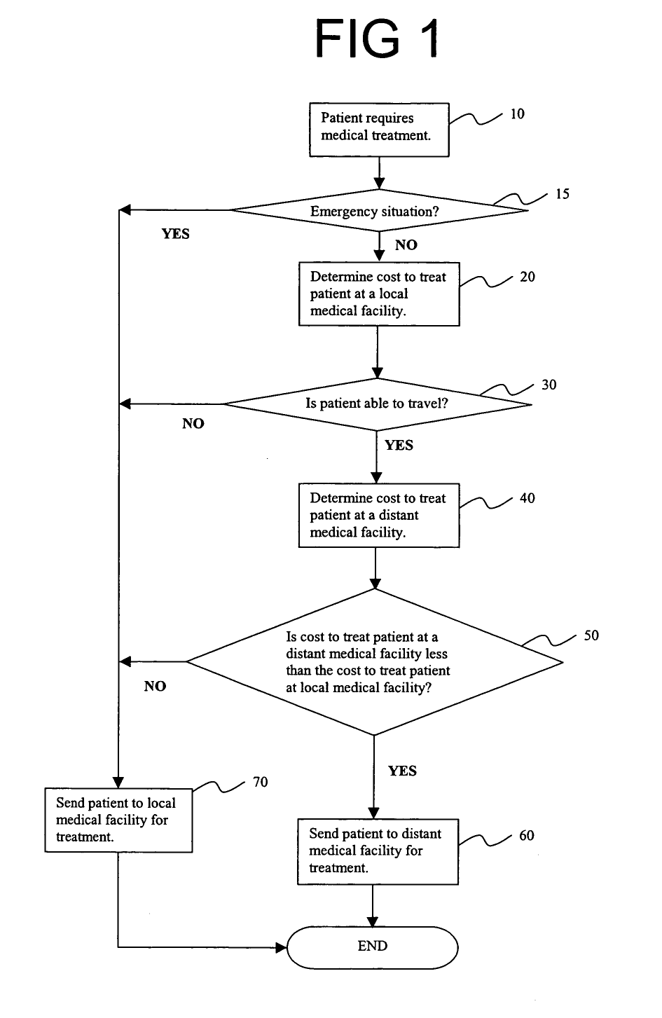

10—patient requires medical treatment
15—emergency situation
20—determine cost of local medical treatment
30—is patient able to travel
40—determine cost of distant medical treatment
50—is distant medical treatment less expensive than local medical treatment
60—send patient to distant medical facility for treatment
70—send patient to local medical facility for treatment
   Description—FIG. 1—Preferred Embodiment

FIG. 1 shows a flow chart of the information and decisions required to select the least expensive medical facility to treat a patient receiving healthcare benefits. The process begins with a patient requiring medical treatment 10. The next step determines if the patient is in an emergency situation 15. The next step determines the cost of treating the patient at a local medical facility 20. This includes but is not limited to the cost to perform the required procedure(s), rehabilitation costs (if required), equipment costs (if required) and any administrative costs (if any). Healthcare Management Organizations (HMO's) compile and updated databases containing this information, making this calculation quick and accurate for people skilled in the art. This is one reason why HMO's require their patients to use doctors and facilities that are within their network.

Next, an assessment is made to determine if a patient is able to travel 30. A patient's ability to travel will be affected by his/her medical condition and/or personal circumstances.

Next, the cost to treat the patient at a distant medical facility is determined 40. This includes but is not limited to the cost to perform the required procedure(s), rehabilitation costs (if required), equipment costs (if required), any administrative costs (if any), the cost to travel to and from the distant medical facility and any recuperation costs that will be incurred there (if any). Contingencies may be included for any unforeseen extended periods of stay. Patients undergoing surgery may not be able to travel right away so the extra time spent at the distant medical facility must be estimated and accounted for in the cost. Databases containing all this information can be created and updated for future use by people skilled in the art of managing healthcare costs.

Next a comparison of the magnitude of the costs to treat the patient at a local medical facility versus a distant medical facility is made 50. My invention contains two conclusions. The first is to treat the patient at a distant medical facility 60. The second is to treat the patient at a local medical facility 70.

Advantages

From the description above, several advantages of my method to reduce healthcare costs becomes evident:
(a) Money can be saved when companies providing healthcare benefits are able to choose from 2 or more medical facilities to provide the same treatment, when the patient is able to travel.
(b) Healthcare costs will fall when medical facilities compete to treat patients.
(c) More people will be able to afford healthcare when medical facilities compete to treat patients at their facility.
(d) My invention can be used to save money when treating patients with mental and/or physical illnesses.
(e) Money and resources will be saved when medical facilities that do not normally function at full capacity (i.e., many empty beds and wasted overhead) are able to compete for patients and function at nearly full capacity, by accommodating patients from outside their normal service area.
   Operation—FIG. 1.

The manner of operating my method to reduce healthcare costs is illustrated in FIG. 1. My method begins with a patient requiring medical treatment 10. An assessment is made as to whether the patient is in an emergency situation 15 or not. This can be identified by assessing the severity of the patient's condition. If the patient requires emergency help then he/she will be treated at a local medical facility 70.

If the patient does not require emergency attention, then the cost of treating the patient's malady at a local medical facility is determined 20 next. This can be done by asking the local medical facility the cost for services such as, but not limited to, treating the patient, rehabilitation costs (if required), how much equipment costs are expected to be (if required) and how much other administrative fees will be. Summing all the expected costs together produces an estimated cost to treat the patient at the local medical facility. Those skilled in the art can determine these costs quickly and accurately.

This is followed by determining if the patient is able to travel 30. This can be determined by the patient's primary care physician, any physician/specialist treating the patient or by asking the patient him/herself. If the patient is unable to travel due to their medical condition or by their personal situation then the patient will be sent to a local medical facility for treatment 70.

If the patient is able to travel, then the cost to treat the patient at a distant medical facility is determined 40. This can be done by asking the distant medical facility the cost for services such as, but not limited to, treating the patient, rehabilitation costs (if required), how much equipment costs are expected to be (if required) and how much other administrative fees will be. This cost will also include the cost for the patient to travel to and from the distant medical facility. Summing all the expected costs together produces an estimated cost to treat the patient at the distant medical facility.

With two (or more) total treatment costs available, a comparison is made to determine if it costs less to treat the patient at the distant medical facility or at the local medical facility 50. If it costs less to treat the patient locally, then the patient will be sent to the local medical facility for treatment 70. However, if it costs less to treat the patient distant medical facility then arrangements will be made to send the patient to the distant medical facility for treatment 60.

### CONCLUSION, RAMIFICATIONS AND SCOPE

Accordingly, the reader will see that my method to reduce healthcare costs is a simple and easy to follow technique a healthcare provider can follow to reduce healthcare costs without jeopardizing a patient's health or wishes. Vigorous competition in the healthcare field can produce substantial societal benefits.

While my above description contains many specificities, these should not be construed as limitations on the scope of the invention, but rather as an exemplification of one preferred embodiment thereof. For example, many of the steps can be performed concurrently. Also as my invention becomes widely used, HMO's will be able to use databases with up to date cost information to find the lowest cost medical facility as soon as a patient requests the need for medical treatment.

Accordingly, the scope of the invention should be determined not by the embodiment illustrated but by the appended claims and their legal equivalents.

I claim:

1. A method to reduce the cost of healthcare, comprising of:
(a) knowledge or estimate of the costs to treat an ailing patient at a local medical facility,
(b) knowledge or estimate of the costs to treat said ailing patient at a distant medical facility,
whereby savings are realized when said patient is sent to the least expensive medical facility for treatment.
